(19) United States
(12) Patent Application Publication
(10) Pub. No.: US 2003/0183710 A1
(43) Pub. Date: Oct. 2, 2003

(54) Jaw crusher

(75) Inventor: Tsukasa Katayama, Yachiyo-shi (JP)

Correspondence Address: OLIFF & BERRIDGE, PLC, P.O. BOX 19928, ALEXANDRIA, VA, 22320, US

(73) Assignee: KAWASAKI JUKOGYO KABUSHIKI KAISHA, Kobe-Shi (JP)

(21) Appl. No.: 10/397,333

(22) Filed: Mar. 27, 2003

(30) Foreign Application Priority Data
Apr. 2, 2002 (JP) 2002-099769

(51) Int. Cl. B02C 1/10

(52) U.S. Cl. 241/264

(57) ABSTRACT

A jaw crusher includes a frame 5 having a front frame 5b and a rear frame 5c, and a swing jaw 8 mounted on a shaft 6 of the frame 5. A backing plate 11 for a spring is disposed at a bottom portion of the frame 5. The backing plate 11 has a horizontal rod 12 inserted therethrough. The horizontal rod 12 is connected to a lower portion of the swing jaw 8, and has compression springs 16 and 17 for locating the horizontal rod 12 in position. A reciprocating linear vibration is transmitted from the vibrator 2 to the swing jaw 8 through an oscillation frame 23 and a vibration transmitting means 3. The vibration transmitting means 3 is connected to the swing jaw 8 through a joint 4.

### FIELD OF THE INVENTION

The present invention relates to a jaw crusher, specifically to a jaw crusher including a swing jaw, an upper portion of which is hinged to a shaft disposed between upper parts of both side frames of a frame, with a lower portion of the swing jaw being capable of swinging forward and rearward relative to a front frame.

### BACKGROUND OF THE INVENTION

As a jaw crusher of this type, a double toggle (break-shaped) jaw crusher is conventionally known (Japanese Patent Laid-Open Publications Nos. 63-97242 (97242/1988) and 63-283763 (283763/1988).

The double toggle jaw crusher includes a shaft disposed between upper parts of both side frames of a frame, and a swing jaw disposed on the shaft in a swinging manner. A lower portion of the swing jaw is urged rearward by means of a tension rod and a compression coil spring. An eccentric shaft is disposed between the upper parts of both sides of the frames on the rear side of the swing jaw. An upper portion of a pitman is swingably attached to the eccentric shaft. Toggle plates are respectively provided between a front portion and a rear portion of a lower portion of the pitman, and the lower portion of the swing jaw and a rear frame. The pitman is vertically moved by rotating the eccentric shaft so as to swing a lower part of the swing jaw forward and rearward relative to a front frame. A rough stone or other object to be processed is thus compressed and crushed by means of a moving tooth mounted on a front portion of the swing jaw and a secured tooth mounted on a rear portion of the front frame.

In a conventional jaw crusher, since a stroke of the swing jaw is fixed, a compression force (crush force) applied to the object to be processed increases as the lower part of the swing jaw approaches the front frame. Thus, in cases where only an argillite contained in a red hematite is to be crushed, only a soft stone or a hard pan contained in a rough stone is to be crushed, or edges of a favorable stone are to be cut to regularize shapes, the conventional jaw crusher is disadvantageous in that even the red hematite, the rough stone, or the favorable stone are liable to be crushed.

### SUMMARY OF THE INVENTION

Therefore, an object of the present invention is to provide a jaw crusher which can crush only an unnecessary portion of an object to be processed.

A jaw crusher according to the present invention comprises a frame including a front frame and a rear frame; a swing jaw which is attached to a shaft disposed at a top portion of the frame, and swings forward and rearward relative to the front frame; a backing plate for a spring disposed at a bottom portion of the frame; a horizontal rod connected to a lower part of the swing jaw and inserted to the backing plate, the rod slidably moving forward and rearward; compression springs respectively disposed between a front portion of the horizontal rod and the backing plate, and a rear portion of the horizontal rod and the backing plate; an oscillation frame; a vibrator allowing the oscillation frame to generate a reciprocating linear vibration in a fore-and-aft direction; and a joint which connects the oscillation frame to the swing jaw so that an angle between the oscillation frame and the swing jaw can vary.

In the jaw crusher according to the present invention, the oscillation frame and the joint may be connected with each other through a vibration transmitting means.

In the jaw crusher according to the present invention, the vibration transmitting means may include a support rod disposed on the top portion of the frame, a vibration transmitting plate supported on the support rod in a swinging manner, and a connecting plate connecting the vibration transmitting plate with the oscillation frame.

In the jaw crusher according to the present invention, the vibrator and the oscillation frame may be disposed on a front side or a rear side of the frame.

In the jaw crusher according to the present invention, the vibrator and the oscillation frame may be disposed on the frame.

In the jaw crusher according to the present invention, a front spring bracket and a rear spring bracket may be respectively provided on a front portion and a rear portion of the horizontal rod, the brackets holding the compression springs between the same and the backing plate, and the front spring bracket and the rear spring bracket may be capable of moving forward and rearward relative to the horizontal rod.

In the jaw crusher according to the present invention, the vibrator and the oscillation frame may be supported above a vibrator frame through a suspender.

In the jaw crusher according to the present invention, the vibrator and the oscillation frame may be supported by the vibrator frame through a support frame and the suspender.

In the jaw crusher according to the present invention, the support frame may be capable of moving forward and rearward relative to the vibrator frame.

In the jaw crusher according to the present invention, the vibrator and the oscillation frame may be supported by the frame through a suspender.

In the jaw crusher according to the present invention, the vibrator and the oscillation frame may be supported by the frame through a support frame and the suspender.

In the jaw crusher according to the present invention, the support frame may be capable of moving forward and rearward relative to the frame.

In the jaw crusher according to the present invention, the joint may include a driving side seat backing plate and driving side seat which are disposed on a side of the vibration transmitting means, and a driven side seat backing plate and a driven side seat which are disposed on a side of the swing jaw, and a hinge rod disposed between the driving side seat and the driven side seat.

In the jaw crusher according to the present invention, the joint further may include a tension rod connected to the driving side seat backing plate, the tension rod having at an end thereof a hook to be engaged with the swing jaw.

According to the present invention, a stroke of a swing jaw is changed depending on an amount of an object to be processed so that a compression force (crush force) applied thereto can be limited to a predetermined force or less.

According to the present invention, since a front spring bracket, a rear spring bracket and a vibrator are moved forward and rearward for adjustment, an outlet gap between a swing jaw and a front frame can be changed.

### BRIEF DESCRIPTION OF THE INVENTION

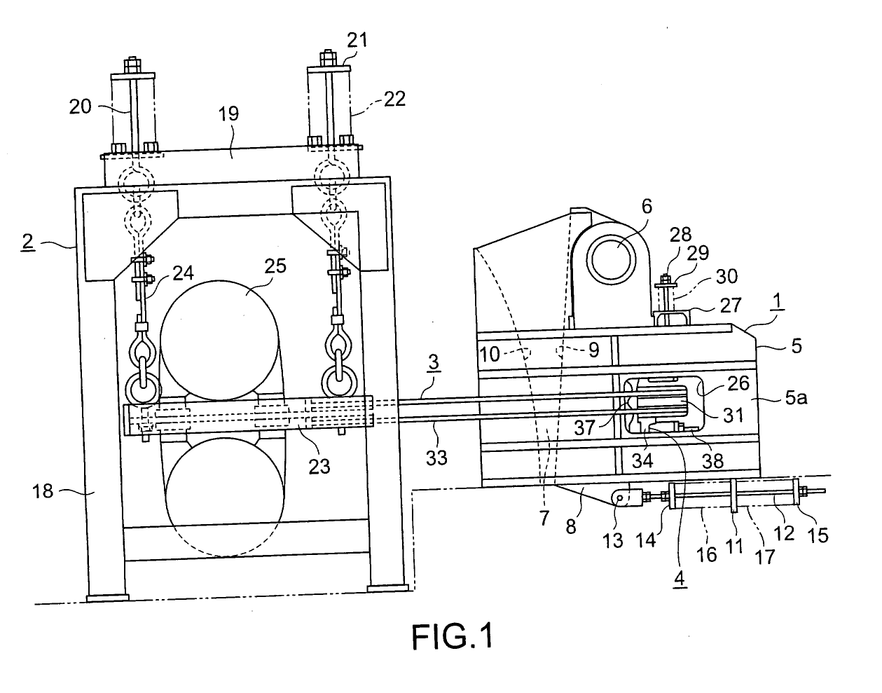

FIG. 1 is a right side view showing a first embodiment of a jaw crusher according to the present invention;

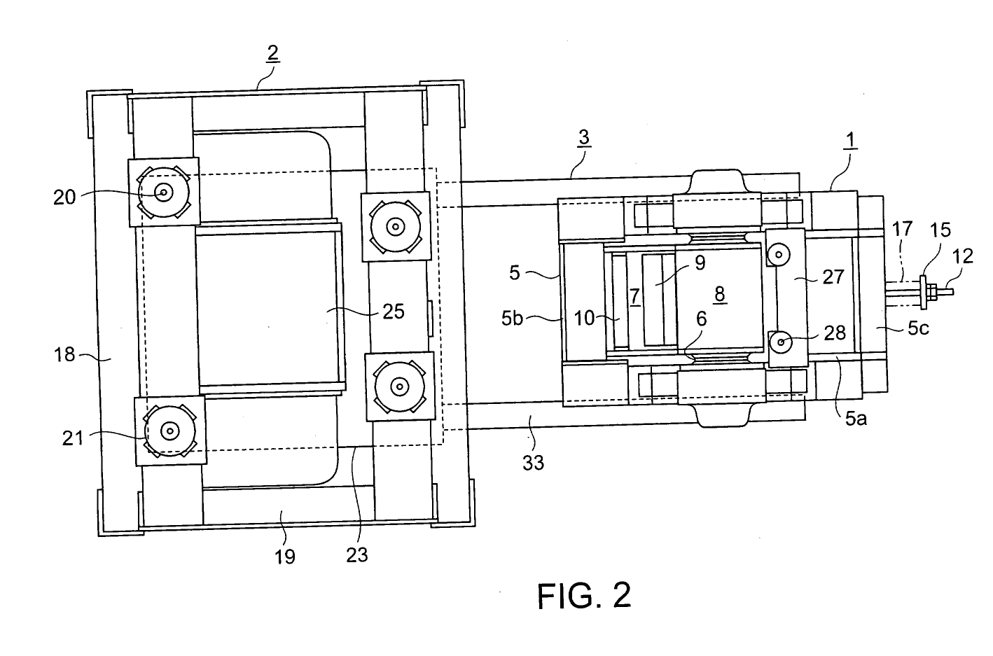

FIG. 2 is a plane view of the jaw crusher shown in FIG. 1;

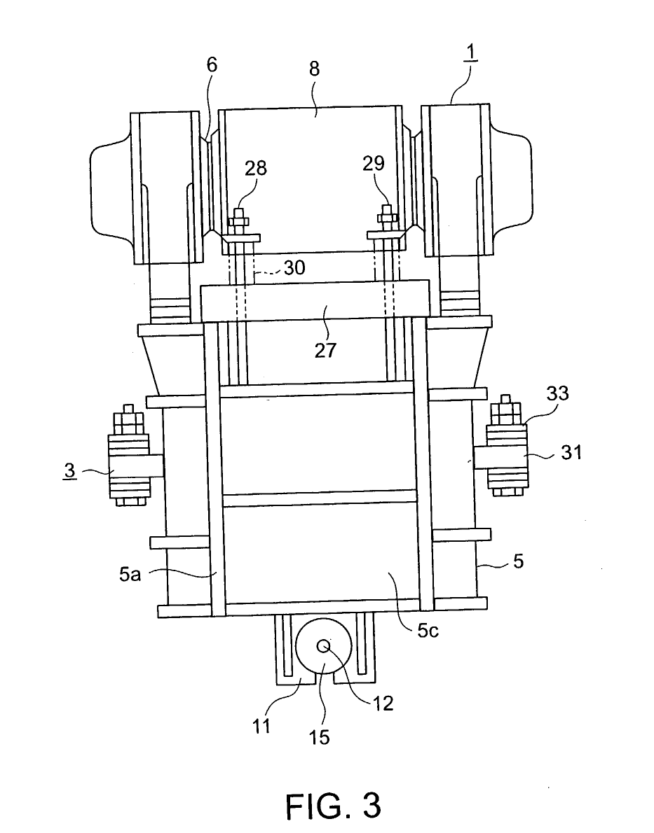

FIG. 3 is a rear view of the jaw crusher shown in FIG. 1;

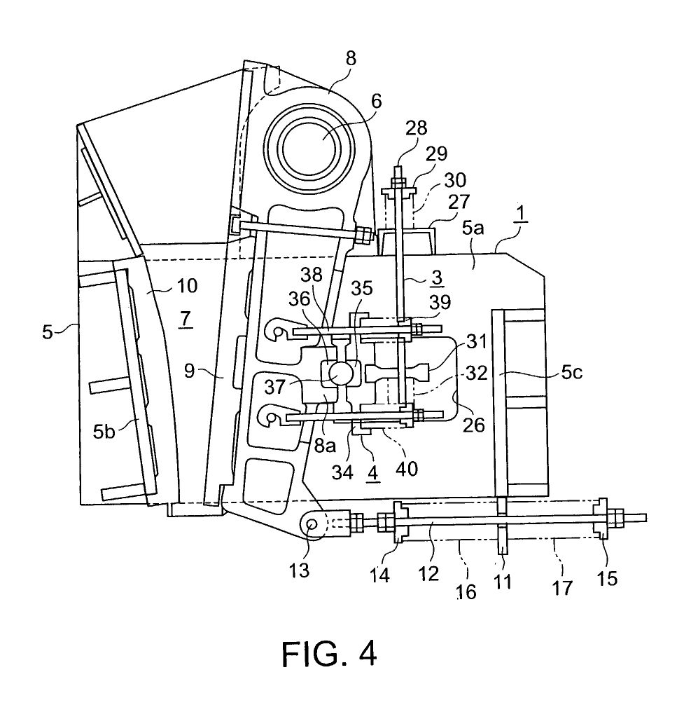

FIG. 4 is a right side cross-sectional view showing a substantial part of the jaw crusher shown in FIG. 1; and

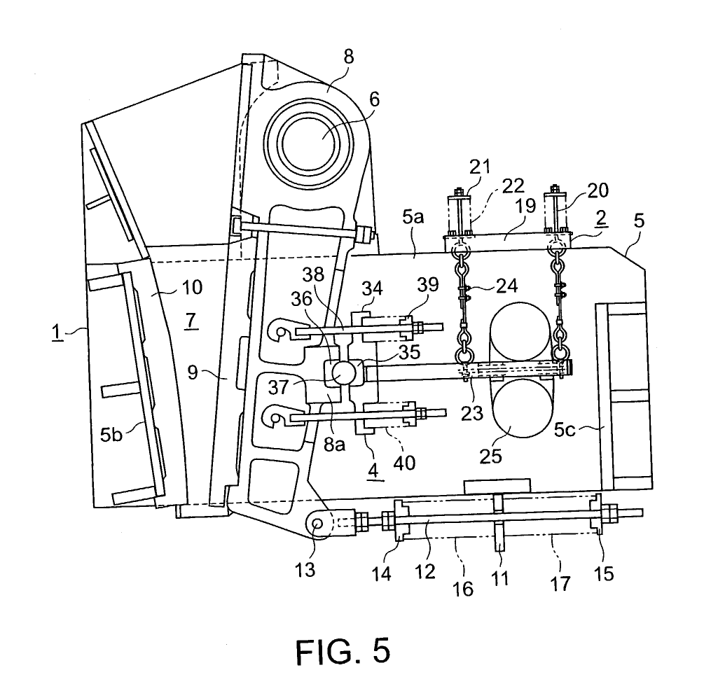

FIG. 5 is a right side cross-sectional view showing a second embodiment of a jaw crusher according to the present invention.

### DETAILED DESCRIPTION OF THE INVENTION

First Embodiment

Embodiments according to the present invention are hereinafter described in detail with reference to the drawings.

FIGS. 1 to 3 respectively show a right side view, a plane view, and a rear view of a first embodiment of a jaw crusher according to the present invention.

The jaw crusher includes a crusher body 1 having a frame 5 and a swing jaw 8; a vibrator 2 which is disposed on a front side (left side in FIGS. 1 and 2) of the crusher body 1 with a suitable space therebetween, and oscillates to generate a reciprocating linear vibration in a fore-and-aft direction (right and left direction in FIGS. 1 and 2); vibration transmitting means 3 which transmits the reciprocating linear vibration of an oscillation frame 23 generated by the vibrator 2; and a joint 4 which connects the vibration transmitting means 3 to a rear portion of the swing jaw 8.

As shown in FIG. 4 in detail, the frame 5 of the crusher body 1 has side frames 5a which are parallel with each other, a front frame 5b which closes front portions (left portions in FIG. 4) of both side frames 5a, and a rear frame 5c which connects rear portions (right portions in FIG. 4) of both side frames 5a with each other. The frame 5 is of a substantially rectangular shape when viewed from above.

A shaft 6 is disposed between top portions of both the side frames 5a of the frame 5. An upper portion of the swing jaw 8 is attached to the shaft 6, the swing jaw 8 defining a crush chamber 7 together with both the side frames 5a and the front frame 5b, with the swing jaw 8 being capable of swinging relative to the front frame 5b. The swing jaw 8 and the front frame 5b have a movable tooth 9 and a fixed tooth 10 mounted respectively thereon in order that an object to be processed is compressed to be crushed.

A backing plate 11 for a spring is vertically disposed at a bottom portion of the rear frame 5c of the frame 5. The backing plate 11 has a rod 12 movably inserted therethrough in a longitudinal direction, which horizontally extends in a fore-and-aft direction (right and left direction in FIG. 4). A front portion of the horizontal rod 12 is pivotally mounted to the lower portion of the swing jaw 8 through a horizontal pin 13.

A front spring bracket 14 and a rear spring bracket 15 are respectively provided to a front portion and a rear portion of the rod 12, the brackets 14 and 15 being capable of moving forward and rearward along the rod 12. Compression coil springs 16 and 17 are respectively disposed between the front spring bracket 14 and a front surface of the backing plate 11, and the rear spring bracket 15 and a rear surface of the backing plate 11 so that the lower portion of the swing jaw 8 which is swung by the vibrator 2 can be returned in a desirable position.

As shown in FIGS. 1 and 2, the vibrator 2 has a vibrator frame 18 of an approximately rectangular parallelepiped shape. A support frame 19 of a rectangular shape when viewed from above is mounted on the frame 18 such that the support frame 19 can move forward and rearward. Two-vertical support rods 20 are respectively inserted to a front portion and a rear portion of the support frame 19 in a vertically movable manner. Compression coil springs 22 are disposed between spring brackets 21 provided on an upper portion of the respective rods 20 and the support frame 19 so as to resiliently support the oscillation frame 23.

The oscillation frame 23 of a rectangular shape when viewed from above is horizontally suspended by a lower portion of each support rod 20 through a suspender 24 in a vibrator frame 18 in such a manner that the oscillation frame 23 is capable of moving forward and rearward. Oscillators 25 are respectively mounted on an upper side and a lower side of the oscillation frame 23. The oscillators 25 allow the oscillation frame 23 to generate a horizontal reciprocating linear vibration in a fore-and-aft direction by synchronically rotating at least two pairs of unbalanced weights in a direction opposite to each other.

As shown in FIG. 4 in detail, substantially rectangular shaped windows 26 are respectively provided on both side frames 5a of the frame 5 of the crusher body 1 such that the windows 26 are positioned on a side of a rear surface of the swing jaw 8. A support mounting 27 constituting a part of the vibration transmitting means 3 is disposed above the windows 26 in a lateral direction. A pair of suspending rods 28 which vertically extend are inserted through both end portions of the respective support mounting 27, the rods 28 being capable of vertically moving. Compression coil springs 30 are respectively disposed between spring brackets 29 provided on upper portions of the respective suspending rods 28 and the support mounting 27 in order to resiliently suspend a vibration transmitting plate which is described below.

A lower portion of each suspending rod 28 is positioned on a rear side of a center part of the swing jaw 8. Each suspending rod 28 is inserted through both end portions of a horizontal vibration transmitting plate 31 of a rectangular shape which projects from each window 26. Compression coil springs 32, which resiliently hold the vibration transmitting plate 31 together with the compression coil springs 30, are respectively provided between brackets (not shown) provided on lower portions of the respective suspending rods 28 and the vibration transmitting plate 31.

As shown in FIGS. 1 to 3, both end portions of the vibration transmitting plate 31 are connected with the oscillation frame 23 of the vibrator 2 and a connecting plate 33.

The joint 4 connects the vibration transmitting plate 31 of the vibration transmitting means 3 to a rear portion of the swing jaw 8 of the crusher body 1 so that an angle between the oscillation frame 23 and the swing jaw 8 and an angle between the vibration transmitting plate 31 and the swing jaw 8 can vary. As shown in FIG. 4, the joint 4 has a vertical driving side seat backing plate 34 of a rectangular shape which is positioned in the frame 5 and attached to a front periphery of the vibration transmitting plate 31; a driving side seat 35 with a horizontal groove of a semi-circular cross section, which is attached to a front surface of the seat backing plate 34; a driven side seat bracket 8a which is projectingly disposed on a rear surface of a center part of the swing jaw 8 to be opposed to the driving side seat backing plate 34; a driven side seat 36 with a horizontal groove of a semi-circular cross section, which is attached to a rear surface of the driven side seat bracket 8a; a hinge rod 37 of a circular cross section which is interposed between the seats 35 and 36. Four horizontal tension rods 38 which can move in a fore-and-aft direction are inserted through an upper part and a lower part of both end portions of the driving side seat backing plate 34. Each tension rod 38 has at a front end thereof a hook 38a to be engaged with the swing jaw 8.

Compression coil springs 40 are respectively disposed between spring brackets 39 provided at rear portions of the respective tension rods 38 and the driving side seat backing plate 34 so that the hinge rod 37 is always engaged with the driving side seat 35 and the driven side seat 36.

In the above jaw crusher, the front spring bracket 14 and the rear spring bracket 15 of the rod 12 disposed at the bottom portion of the frame 5, and the support frame 19 supporting the vibrator 2 are suitably moved forward and rearward so as to adjust the outlet gap of the crush chamber 7 between the swing jaw 8 and the front frame 5b. Then, the oscillators 25 of the vibrator 2 are driven to allow the oscillation frame 23 to generate a horizontal reciprocating linear vibration in a fore-and-aft direction. The vibration thus generated is transmitted to the swing jaw 8 through the vibration transmitting means 3 and the joint 4 to swing the lower part of the swing jaw 8 relative to the front frame 5b. When an object to be processed is thrown into the crush chamber 7, a stroke of the swing jaw 8 is changed depending on an amount of the object to be processed. Therefore, the object to be processed is compressed and crushed with a fixed compression force applied thereto, and is discharged from the lower portion of the crush chamber 7.

In this manner, only an unnecessary portion of the object to be processed, e.g., an argillite in a red hematite, a soft stone in a rough stone, or angles of a favorable stone, is crushed.

In the above-described embodiment, although the vibrator 2 is located at a front side of the crusher body 1, the invention is not limited thereto. The vibrator 2 may be located at a rear side of the crusher body 1 with a suitable space therebetween, which produces the same function and effect.

Second Embodiment

FIG. 5 is a right side cross-sectional view showing a second embodiment of a jaw crusher according to the present invention.

In the first embodiment, the vibrator 2 which is driven to swing the lower part of the swing jaw 8, is located at a front side of the crusher body 1, and the vibration of the oscillation frame 23 is transmitted to the swing jaw 8 through the vibration transmitting means 3 and the joint 4. On the other hand, in the second embodiment, neither vibrator frame 18 nor vibration transmitting means 3 are employed, and the support frame 19 of the vibrator 2 is mounted on a rear portion of the frame 5 of the crusher body 1 such that the support frame 19 can move forward and rearward. The oscillation frame 23 having the oscillators 25 mounted thereon is resiliently suspended by the support frame 19. The oscillation frame 23 and the rear portion of the swing jaw 8 are connected to each other through the joint 4 so that an angle between the oscillation frame 23 and the swing jaw 8 can vary.

Since other constitutions and effects are substantially the same with those of the first embodiment, the parts having the same constitution have the same reference numbers and their detailed description is omitted.

In each embodiment, the front spring bracket 14 and the rear spring bracket 15 of the rod 12 located at the bottom of the frame 5 of the crusher body 1 and the support frame 19 of the vibrator 2 are movably disposed in a fore-and-aft direction, so that the outlet gap of the crush chamber 7 between the swing jaw 8 and the front frame 5b can be adjusted. However, the invention is not limited thereto. The front spring bracket 14, the rear spring bracket 15, and the support frame 19 may be secured.

In such constitution, it is preferable to dispose an adjusting plate or a belt conveyor below the outlet of the crush chamber 7 in order to adjust a discharged amount of an object to be processed.

The vibration transmitting means 3 and the oscillation frame 23 are connected to the swing jaw 8 through the joint 4 which is composed of the driving side seat backing plate 34, the seat bracket 8a, the hinge rod 37, and the seats 35 and 36. However, a connection therebetween may be achieved by means of a pin joint.

As described above, according to the present invention, since a stroke of a swing jaw is changed depending an amount of an object to be processed, a compression force (crush force) applied thereto can be fixed. Accordingly, a jaw crusher according to the present invention can crush only an unnecessary portion of the object to be processed, e.g., an argillite in a red hematite, a soft stone in a rough stone, or angles of a favorable stone.

1. A jaw crusher comprising:
a frame including a front frame and a rear frame;
a swing jaw which is attached to a shaft disposed at a top portion of the frame, and swings forward and rearward relative to the front frame;
a backing plate for a spring disposed at a bottom portion of the frame;
a horizontal rod connected to a lower part of the swing jaw and inserted to the backing plate, the rod slidably moving forward and rearward;
compression springs respectively disposed between a front portion of the horizontal rod and the backing plate, and a rear portion of the horizontal rod and the backing plate;
an oscillation frame;
a vibrator allowing the oscillation frame to generate a reciprocating linear vibration in a fore-and-aft direction; and
a joint which connects the oscillation frame to the swing jaw so that an angle between the oscillation frame and the swing jaw can vary.

2. A jaw crusher according to claim 1, wherein
the oscillation frame and the joint are connected with each other through a vibration transmitting means.

3. A jaw crusher according to claim 2, wherein
the vibration transmitting means includes a support rod disposed on the top portion of the frame, a vibration transmitting plate supported on the support rod in a swinging manner, and a connecting plate connecting the vibration transmitting plate to the oscillation frame.

4. A jaw crusher according to claim 1, wherein
the vibrator and the oscillation frame are disposed on a front side or a rear side of the frame.

5. A jaw crusher according to claim 1, wherein
the vibrator and the oscillation frame are disposed on the frame.

6. A jaw crusher according to claim 1, wherein
a front spring bracket and a rear spring bracket are respectively provided on a front portion and a rear portion of the horizontal rod, the brackets holding the compression springs between the same and the g backing plate, and wherein
the front spring bracket and the rear spring bracket are capable of moving forward and rearward relative to the horizontal rod.

7. A jaw crusher according to claim 4, wherein
the vibrator and the oscillation frame are supported by a vibrator frame through a suspender.

8. A jaw crusher according to claim 7, wherein
the vibrator and the oscillation frame are supported by the vibrator frame through a support frame and the suspender.

9. A jaw crusher according to claim 8, wherein
the support frame is capable of moving forward and rearward relative to the vibrator frame.

10. A jaw crusher according to claim 5, wherein
the vibrator and the oscillation frame are supported by the frame through a suspender.

11. A jaw crusher according to claim 10, wherein
the vibrator and the oscillation frame are supported by the frame through a support frame and the suspender.

12. A jaw crusher according to claim 11, wherein
the support frame is capable of moving forward and rearward relative to the frame.

13. A jaw crusher according to claim 1, wherein
the joint includes a driving side seat backing plate and driving side seat which are disposed on a side of the vibration transmitting means, and a driven side seat backing plate and a driven side seat which are disposed on a side of the swing jaw, and a hinge rod disposed between the driving side seat and the driven side seat.

14. A jaw crusher according to claim 13, wherein
the joint further includes a tension rod connected to the driving side seat backing plate, the tension rod having at an end thereof a hook to be engaged with the swing jaw.
